(19) United States
(12) Patent Application Publication
(10) Pub. No.: US 2026/0367976 A1
(43) Pub. Date: Nov. 19, 2026

(54) RESOURCE MANAGEMENT SYSTEM

(71) Applicant: HITACHI VANTARA, LTD., Yokohama-shi (JP)

(72) Inventors: Kazuei HIRONAKA, Campbell, CA (US); Hiroyuki OSAKI, Los Gatos, CA (US)

(21) Appl. No.: 19/207,166

(22) Filed: May 13, 2025

(51) Int. Cl. G06F 9/50

(52) U.S. Cl. CPC G06F 9/5027

(57) ABSTRACT

Systems and methods involve for a selection of a policy for resource allocation, retrieving a configuration priority for the selected policy; determining a destination storage system for the retrieved configuration priority; determining provisioned capacity of the destination storage system. For the provisioned capacity exceeding a reserve capacity of the destination storage system, they can further include retrieving a next configuration priority for the selected policy for when the destination storage system has insufficient capacity for the configuration priority, or for when the destination storage system cannot satisfy minimum reserve capacities of other policies should requested capacity be allocated for the configuration priority; and allocating the requested capacity for the selected policy for when the destination storage system has sufficient capacity for the configuration priority and for when the destination storage system can satisfy minimum reserve capacities of the other policies should the requested capacity be allocated for the configuration priority.

### BACKGROUND

### Field

The present disclosure is generally directed to Information Technology (IT) management systems, and more specifically, to resource management systems and methods.

### Related Art

IT management systems have become more complex and the number of skilled IT professionals are limited. The IT management systems are required to be automated and easy to use for the end-users. Storage administrators are often required to have a deep understanding of the storage systems, the data protection technologies, and limitations of the storage systems.

To simplify the storage management, Saas (Software as a Service) based storage management systems are becoming more utilized. The SaaS based storage management system often provides intuitive user interfaces, pre-defined configuration policies, and automated resource management. Using the pre-defined configuration policies, the SaaS based storage management system can automatically find the appropriate resources to meet the user's intent and the SLAs (Service Level Agreements) and configure the storage system automatically. Such implementations can reduce the risk of human error and the time to configure the storage system.

Moreover, the SaaS based storage management system possibly provides the self-service interfaces for the system's end-users to configure the storage system by themselves without the help of the storage administrators. In general, the style of management is called storage as a service (STaaS).

In the STaaS, the storage provider offers the storage services to the end-users as a service. The end-users can select the storage services from the service menu (pre-defined configuration policies) and input the SLAs (Service Level Agreements) to meet their intent. The storage management system automatically finds the appropriate resources to meet the user's intent and the SLAs, and configure the storage system automatically.

As storage providers offer storage services to the end-users, the storage provider needs to optimize the system resources to meet the end-users' demands and to reduce the cost of the infrastructure. To achieve this, the storage management system needs to maximize the utilization of the infrastructure resources and efficiently allocate the resources to meet the SLAs.

Related art implementations can include pool volume management unit known as ‘aggregate’. The aggregate is a pool of storage resources that can be used to create volumes. The aggregate can be configured with different RAID (Redundant Array of Inexpensive Disks) levels, disk types, and other storage attributes to meet the performance and capacity requirements of the volumes. The aggregate can also be expanded by adding more disks or storage systems to increase the available storage capacity. When the user creates a volume, the system automatically selects the appropriate aggregate based on the volume requirements and the available resources in the storage system. The system also monitors the capacity and performance of the aggregate and if the aggregate is running out of space or performance, the system can automatically expand the aggregate or move the volume to another aggregate to balance the load.

### SUMMARY

For resource managements, the storage provider needs to monitor the available resources of the infrastructure such as the capacity of the storage system, the network bandwidth, the latency, the performance of the storage system. The storage provider provides storage services as a service menu (hereinafter referred to as policy) to the end-users. Therefore, the storage provider needs to understand how much resources are remaining in the infrastructure at policy level.

In some cases, the policy can allocate and consume the resources that are required for another policy. For example, suppose policy A configures the remote copy from one storage system to another storage system. Meanwhile, policy B configures the remote copy having high performance and high availability. Policy A may consume the network bandwidth and storage capacity that are need to meet the SLAs of policy B. Thus, the remaining resource capacity of the infrastructure for each policy cannot be calculated by simply looking at the overall available resources of the infrastructure, as multiple policies could be consuming the resources at the same time. This can cause complexity in resource management and can lead to over or under-provisioning of resources.

When a specific policy that requires strict SLAs or is otherwise highly demanded by the end-users shares the resources with other policies, the available resources for policy that requires strict SLAs could become insufficient.

Example implementations described herein are directed to facilitating concise and accurate resource capacity management for each policy regarding the shared resources between policies. Example implementations further facilitate a preferred selection of the resources by each policy. The preferred selection of the resources can avoid resource contention between policies, and can guarantee that the policy having strict requirements can be deployed without resource contention with other less strict policies.

Aspects of the present disclosure can involve a method, including, for a selection of a policy for resource allocation, retrieving a configuration priority for the selected policy; determining a destination storage system for the retrieved configuration priority; and determining provisioned capacity of the destination storage system; for the provisioned capacity exceeding a reserve capacity of the destination storage system, retrieving a next configuration priority for the selected policy for when the destination storage system has insufficient capacity for the configuration priority, or for when the destination storage system cannot satisfy minimum reserve capacities of other policies should requested capacity be allocated for the configuration priority; and allocating the requested capacity for the selected policy for when the destination storage system has sufficient capacity for the configuration priority and for when the destination storage system can satisfy minimum reserve capacities of the other policies should the requested capacity be allocated for the configuration priority.

Aspects of the present disclosure can involve, a computer program, having instructions for executing a process, which can include, for a selection of a policy for resource allocation, retrieving a configuration priority for the selected policy; determining a destination storage system for the retrieved configuration priority; and determining provisioned capacity of the destination storage system; for the provisioned capacity exceeding a reserve capacity of the destination storage system, retrieving a next configuration priority for the selected policy for when the destination storage system has insufficient capacity for the configuration priority, or for when the destination storage system cannot satisfy minimum reserve capacities of other policies should requested capacity be allocated for the configuration priority; and allocating the requested capacity for the selected policy for when the destination storage system has sufficient capacity for the configuration priority and for when the destination storage system can satisfy minimum reserve capacities of the other policies should the requested capacity be allocated for the configuration priority. The computer program and instructions can be stored on a non-transitory computer readable medium and executed by one or more processor.

Aspects of the present disclosure can involve a system, including, for a selection of a policy for resource allocation, means for retrieving a configuration priority for the selected policy; means for determining a destination storage system for the retrieved configuration priority; and means for determining provisioned capacity of the destination storage system; for the provisioned capacity exceeding a reserve capacity of the destination storage system, means for retrieving a next configuration priority for the selected policy for when the destination storage system has insufficient capacity for the configuration priority, or for when the destination storage system cannot satisfy minimum reserve capacities of other policies should requested capacity be allocated for the configuration priority; and means for allocating the requested capacity for the selected policy for when the destination storage system has sufficient capacity for the configuration priority and for when the destination storage system can satisfy minimum reserve capacities of the other policies should the requested capacity be allocated for the configuration priority.

Aspects of the present disclosure can involve a storage management system, configured to manage one or more storage systems, which can include a processor, configured to, for a selection of a policy for resource allocation, retrieve a configuration priority for the selected policy; determine a destination storage system from the one or more storage systems for the retrieved configuration priority; and determine provisioned capacity of the destination storage system; for the provisioned capacity exceeding a reserve capacity of the destination storage system, retrieve a next configuration priority for the selected policy for when the destination storage system has insufficient capacity for the configuration priority, or for when the destination storage system cannot satisfy minimum reserve capacities of other policies should requested capacity be allocated for the configuration priority; and allocate the requested capacity for the selected policy for when the destination storage system has sufficient capacity for the configuration priority and for when the destination storage system can satisfy minimum reserve capacities of the other policies should the requested capacity be allocated for the configuration priority.

### BRIEF DESCRIPTION OF DRAWINGS

FIG. 1 illustrates an example problem illustration.

FIG. 2 illustrates an overview of the storage management system, in accordance with an example implementation.

FIG. 3 illustrates an example use case of the storage management system, in accordance with an example implementation.

FIG. 4 illustrates an example of deploying storage configuration with policy while meeting the SLAs, in accordance with an example implementation.

FIG. 5 illustrates an example of the volume database in the resource management module, in accordance with an example implementation.

FIG. 6 illustrates an example service catalogue table, in accordance with an example implementation.

FIG. 7 illustrates the data copy feature catalogue, in accordance with an example implementation.

FIG. 8 illustrates an example of the storage resource database, in accordance with an example implementation.

FIG. 9 illustrates a network resource database, in accordance with an example implementation.

FIG. 10 illustrates an example of the resource level policy quota, in accordance with an example implementation.

FIG. 11 illustrates an example of the service level capacity database, in accordance with an example implementation.

FIG. 12 illustrates the resource allocation process in the resource management module, in accordance with an example implementation.

FIG. 13 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means or can be implemented through a desired algorithm. Example implementations as described herein can be utilized either singularly or in combination and the functionality of the example implementations can be implemented through any means according to the desired implementations.

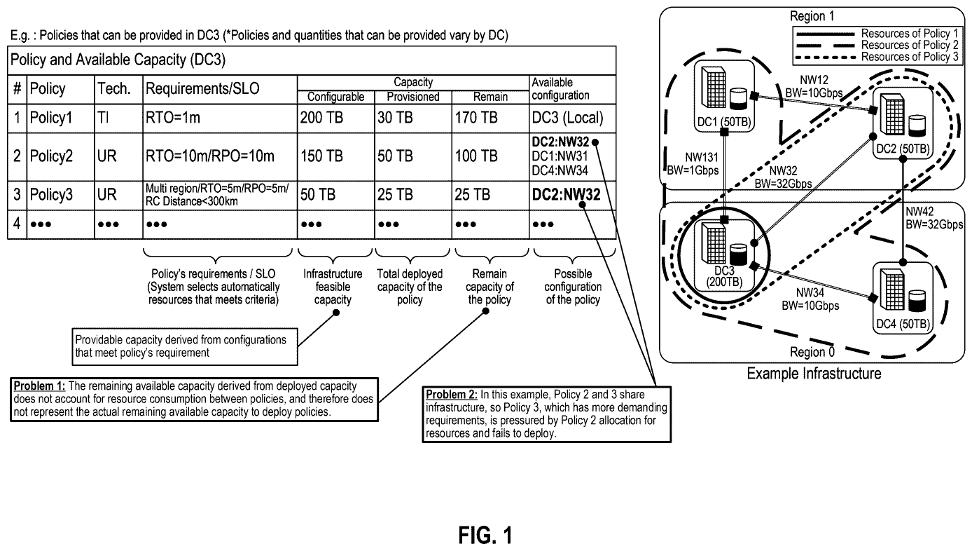

FIG. 1 illustrates an example problem illustration. On the left side, the infrastructure has four storage systems in DC1, DC2, DC3 and DC4 across two different regions (Region 0 and Region 1). Every storage system manages a providable storage service menu (policy) and providable capacity for each policy. In this example, the storage system in DC3 can provide Policy 1, Policy 2, and Policy 3 and so on. Each policy has attributes such as the data copy method, requirements of the SLAs, configurable capacity in the current infrastructure configuration, provisioned capacity by the policy and selectable resource configuration by the policy. For example, Policy1 is a local snapshot policy having requested and specific requirements. For Policy 1, the available selectable resource configuration is only DC3 for local snapshot. The configurable capacity is 200 TB, and the provisioned capacity is 30 TB, thus the remaining capacity is 170 TB.

In the same way, Policy 2 and Policy 3 are remote copy policies. However, Policy 3 has stricter requirements than Policy 2, such as configure remote copy between multiple storage systems across different regions. Policy 2 and Policy 3 may share the same infrastructure resources such as network bandwidth, storage capacity, and so on. If Policy 2 becomes more demanded by the end-users than Policy 3, the available resources for Policy 3 could become insufficient.

Shared resources between policies could be hindered by the remaining resource capacity of the infrastructure for each policy. As a result, it can be difficult for the storage provider hard to get an accurate remaining resource capacity for each policy, which can lead to over or under-provisioning of resources.

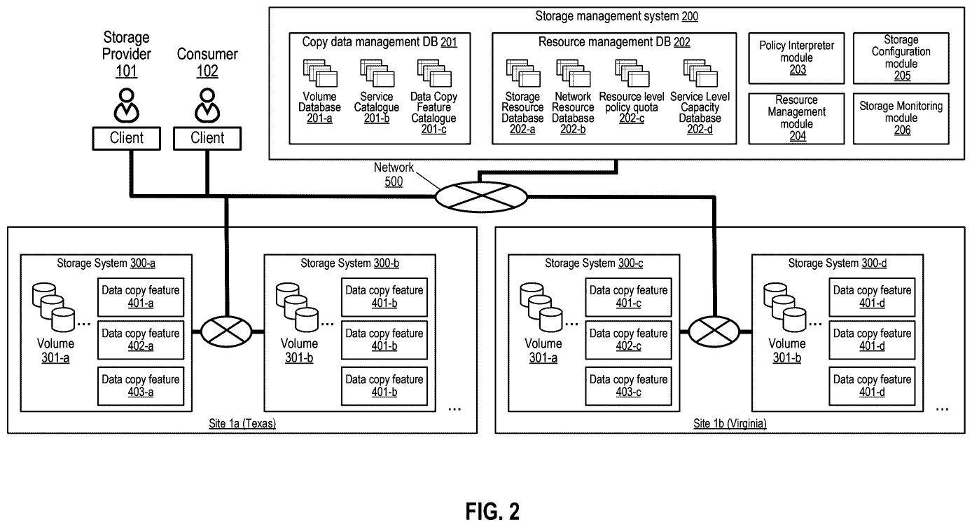

FIG. 2 illustrates an overview of the storage management system, in accordance with an example implementation. Storage provider 101 is responsible for offering storage services, which may involve provisioning, management, and maintenance of storage resources. The storage provider 101 interacts with various components of the system to ensure that storage services are delivered effectively to the consumer 102. Consumer 102 utilizes the storage services provided by the storage provider 101. Examples of consumer 102 can include end-users, client applications, or another IT system that consumes storage resources. Storage provider 101 and consumer 102 may have associated clients which are the end points that interact with the storage system and storage management system. They would be the devices or applications that use the storage services for operations such as saving and retrieving data.

Site 1a and Site 1b represent different locations or data centers where storage systems are deployed. Each site can have its own storage systems. Storage system 300-a, 300-b, 300-c, 300-d are the storage systems at different sites (Site 1a and Site 1b), which are likely geographically distributed. Each system has its own volumes and data copy features. Storage management system 200 is the centralized management application or service that oversees storage systems, handling tasks such as provisioning, data copy management, and resource management.

Copy data management database (DB) 201 manages the replication of data within the storage system. It includes the following elements. Volume database 201-a contains information about the storage volumes, such as their capacity, performance characteristics, and current usage. It can also store metadata regarding the data stored within these volumes, such as access permissions, data protection policies, and other attributes. Service catalogue 201-b is a predefined list of data protection policies that the provider offers to the consumer. It can include options such as backup frequency, retention periods, replication targets, data copy methods, and other parameters. Data copy feature catalogue 201-c contains information about the available data copy features that can be used for data protection. It can include options such as snapshot, mirroring, remote replication, and other features that can be applied to the data. Further, data copy feature catalogue 201-c could include the information about information about data copy path such as source and destination of the storage system, the available network path for the data transfer, and so on.

Resource management DB 202: contains information about the resources within the storage system, which includes the following elements. Storage resource database 202-a contains information about the storage systems that are available for use. It can include details such as the storage system type, storage system location, available capacity, performance characteristics, and other attributes. Network resource database 202-b contains information about the network infrastructure that is available for data protection operations. It can include details such as the bandwidth, latency, reliability, and other characteristics of the network paths that are used for data transfer between storage systems. Service level capacity database 202-c contains information about the remaining resource capacity of the infrastructure for each policy. It can include details such as the remaining capacity of servable capacity of each policy, provisioned capacity by the policy, and selectable resource configurations (preferred selection of the resources) by the policy. The remaining resource capacity of the infrastructure for each policy can be calculated by the system based on the information from the Storage resource database 202-a and the Network resource database 202-b.

Network 500 represents the networking infrastructure that connects all components of the system, which can encompass local area networks (LANs), wide area networks (WANs), and/or the internet.

Policy interpreter module 203 interprets and applies policies within the storage management system. It ensures that operations adhere to predefined rules and compliance standards.

Resource management module 204 is responsible for the allocation and optimization of resources within the storage system, ensuring efficient use of storage and network components.

Storage configuration module 205 handles the initial setup and ongoing configuration changes in the storage system.

Storage monitoring module 206 monitors the performance and health of the storage systems, providing real-time data on storage usage, performance metrics, network traffic that used for remote replication, and other relevant information.

Volumes 301-a, 301-b, 301-c, 301-d represent the actual data storage containers in each storage system where data is stored and managed.

Data copy feature 401-a, 401-b, 401-c, 401-d, 402-a, 402-b, 402-c, 402-d, 403-a, 403-b, 403-c, 403-d are available for use in the storage systems. The features can include options such as snapshot, mirroring, remote replication, and other features that can be applied to the volumes.

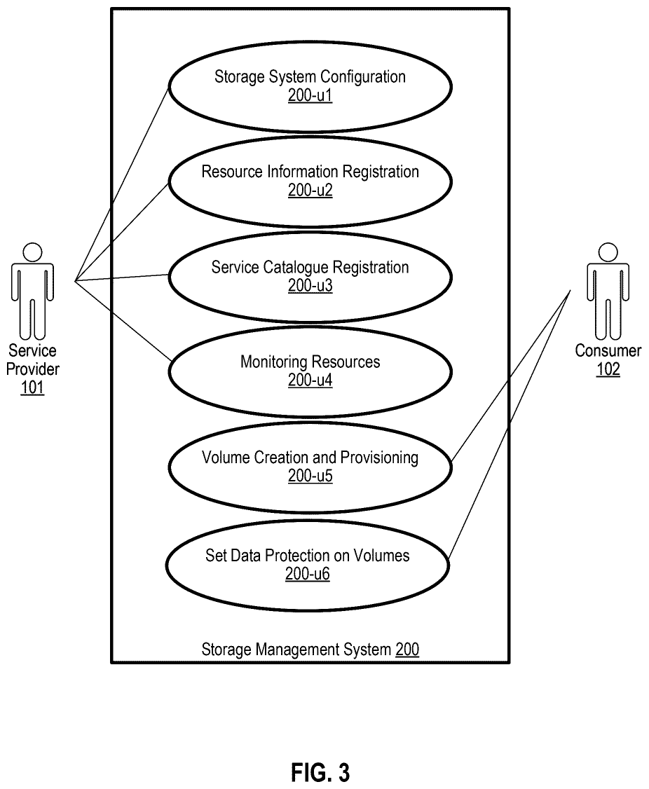

FIG. 3 illustrates an example use case of the storage management system 200, in accordance with an example implementation.

Storage system configuration (200-u1) is a use case that is responsible for configuring the storage systems within the management system by the service provider. It can include tasks such as changing storage system settings, deploying configurations, and other management operations.

Resource information registration (200-u2) is a use case that is responsible for registering the resources that are available for use within the storage management system by the service provider. It can include storage systems, network infrastructure, and other resources that are used for data protection.

Service catalogue registration (200-u3) is a use case that is responsible for registering the data protection services that are available for use within the storage management system by the service provider. It can include options such as backup frequency, retention periods, replication targets, data copy methods, and other parameters.

Monitoring resources (200-u4) is a use case that is responsible for monitoring the resources that are used within the storage management system by the service provider. It can include tasks such as performance monitoring, capacity planning, and other resource management operations.

Volume creation and provisioning (200-u5) is a use case that is for creating and provisioning storage volumes within the storage management system by the consumer. It can include tasks such as creating new volumes, allocating storage capacity, configuring access permissions, and so on.

Set data protection on volumes (200-u6) is a use case that is for setting data protection policies on the volumes within the storage management system by the consumer. It can include tasks such as defining backup schedules, retention periods, replication targets, and other data protection parameters.

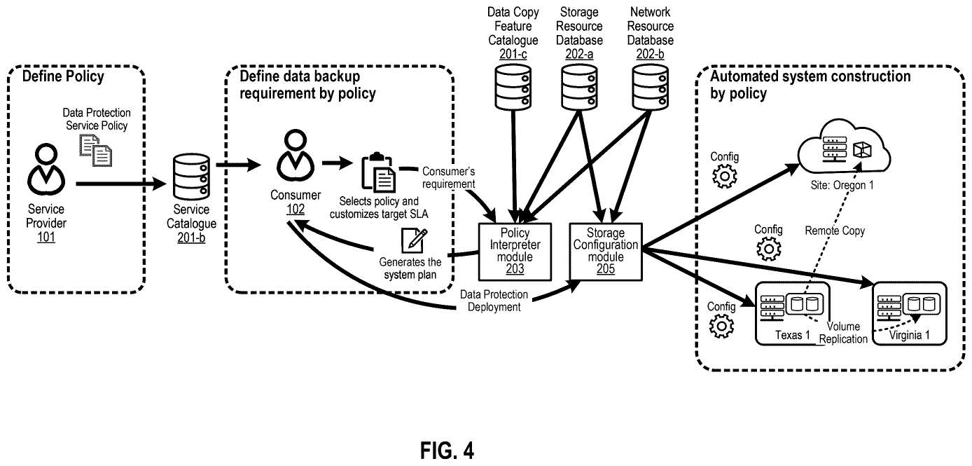

FIG. 4 illustrates an example of deploying storage configuration with policy while meeting the SLAs, in accordance with an example implementation. This figure shows the workflow of the data protection with policies, and setting the SLAs.

A typical workflow is as follows:

Define policy: The Service Provider (101) defines data protection policy as service menu. The defined policies are recorded in the Service Catalogue (201-b), which acts as a repository for the available data backup service options for the consumer (102). The defined policy can include options such as backup frequency, retention periods, replication targets, data copy methods, and other parameters.

Examples of backup policies can be as follows:
Backup policy 1: Remote backup to the cloud storage every day
Backup policy 2: Local backup to the on-premises storage every week
Backup policy 3: Remote backup to the cloud storage every month

In example implementations, the backup policy can include information about the specific data copy method such as snapshot, mirroring, remote replication, and so on. In other example implementations, the backup policy can include the information about the specific data copy path such as source and destination of the storage system, the available network path for the data transfer, and so on. In other example implementations, the backup policy can include information about service level quotas such as the maximum data size, the maximum number of backup copies, the maximum retention period of the backup data, and so on. In other example implementations, the backup policy can include the data placement policy such as the data restriction on the geographical location, the storage cost, the emission of CO2, and so on.

In other example implementations, the backup policy can include priority information indicating what metrics should be prioritized when the system selects the resources to meet the SLAs. For example, the system can prioritize data storage cost over the RTO (Recovery Time Objective) when the cost is the most important factor for the consumer, or the system can prioritize the CO2 emission over the data storage cost when the environmental impact is the most important factor for the consumer, and so on.

In other example implementations, the backup policy can include the information about what metrics are allowed to be adjusted by the consumer. For example, the consumer can adjust the RTO (Recovery Time Objective) within the range of 1 hour to 24 hours, the RPO (Recovery Point Objective) within the range of 1 min to 1 week, and so on to prevent the consumer from selecting the impossible SLAs by the system resources.

Define System Requirement by Policy: The Consumer (102) selects a policy from the Service Catalogue (201-b) and customizes the target SLA to fit their needs. The SLA customization could include options such as RTO (Recovery Time Objective), RPO (Recovery Point Objective), data storage cost, emission of CO2, data restriction on the geographical location, and so on.

Examples of SLA customization can be as follows:
RTO (Recovery Time Objective): 1 hour per 1 terabyte
RPO (Recovery Point Objective): 1 day
Data storage cost: $0.01 per gigabyte per month

In example implementations, the customizable SLA can be defined by the service provider and the consumer can select the SLA from the service menu.

In other example implementations, the customizable SLA can be defined by the service provider in certain range of value and the consumer can adjust the SLA within the range.

The Policy Interpreter Module (203) interprets the selected policy and SLA, finds the appropriate resources and data copy features to meet the policy and SLA, and then generates the system configuration plan to the Consumer (102). The Policy Interpreter Module (203) can use the information from the Storage Resource Database (202-a), the Network Resource Database (202-b), and the Data Copy Feature Catalogue (201-c) to find the appropriate resources and data copy features. The Consumer (102) approves the system configuration plan and requests the deployment of the data protection system construction to the Storage Configuration Module (205). The Storage Configuration Module (205) generates the system configuration and apply the configuration to the Storage systems in each site (Site 1, Site 2, Cloud 1 . . . ).

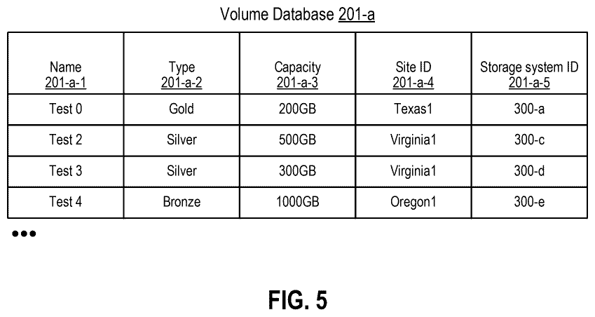

FIG. 5 illustrates an example of the volume database in the resource management module, in accordance with an example implementation. This figure shows the databases that are used in the resource management module and the copy data management module. The table labeled as “Volume Database 201-a” contains information about the storage volumes within the storage system. The table includes columns such as Name, Type, Capacity, Site ID, and Storage system ID.

Name (201-a-1) lists the unique names assigned to each storage volume, which are used to identify and manage the volumes within the system.

Type (201-a-2) classifies each volume by a service level or category, which reflects the performance of the volume. The types listed include “Gold,” “Silver,” and “Bronze,” which are likely used to differentiate between high-performance, medium-performance, and low-performance volumes.

Capacity (201-a-3) indicates the volume capacity.

Site ID (201-a-4) references the location identifier for each volume, showing which site the volume is located at within the broader storage infrastructure such as “Texas 1”, “Oregon 1”, “Virginia1” and so on.

Storage system ID (201-a-5) provides a reference to the specific storage system or array where each volume resides.

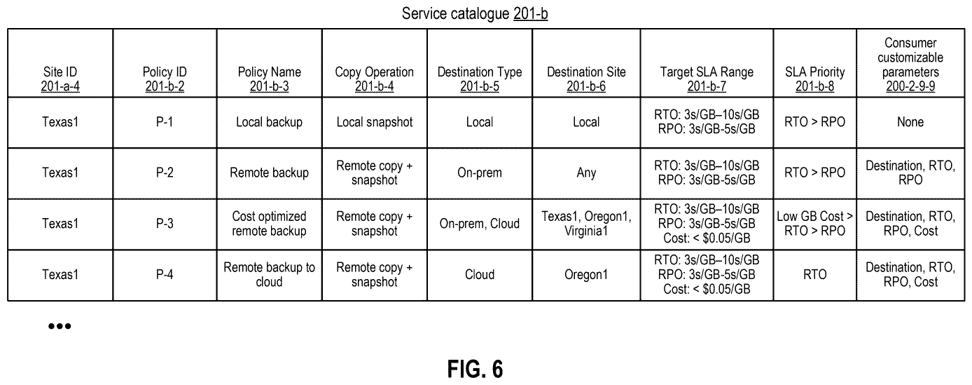

FIG. 6 illustrates an example service catalogue table, in accordance with an example implementation. This figure shows a service catalog table labeled “Service Catalogue 201-b,” representing various data copy policies for each sites within a database. Each column details a specific attribute for each backup service option.

Site ID (201-a-4) identifies the site where the backup policy is available, such as “Texas 1,” “Oregon 1,” “Virginia 1,” and so on. The table of service catalog could be created for each site.

Policy ID (201-b-2) specifies the unique identifier for each policy, such as “P-1,” “P-2,” or “P-3.”

Policy Name (201-b-3) describes the type of backup policy, such as “Local backup,” “Remote backup,” “Cost optimized remote backup,” and “Remote backup to cloud.”

Copy Operation (201-b-4) indicates the data copy operation that performs the policy, such as “Local snapshot,” “Remote copy+Snapshot,” and so on. The mode can be combinations of different data copy methods, such as snapshot, mirroring, and remote replication which are provided by the storage system and defined in the Data Copy Feature Catalogue (201-c).

Destination Type (201-b-5) indicates the destination type for the backup, such as “Local,” “On-prem” (on-premises), “Cloud,” or specific cloud providers like “AWS,” “Azure,” or “Google Cloud.”

Destination Site (201-b-6) provides the destination site for the backup, such as “Local” for local snapshots, “Any” for any available site, or specific site identifiers like “Texas 1”, “Oregon 1”, and so on.

Target SLA Range (201-b-7) lists Service Level Agreements (SLA) for each policy, including Recovery Time Objective (RTO) and Recovery Point Objective (RPO), with typical ranges in seconds per GB, storage cost per GB, and other metrics.

SLA Priority (201-b-8) prioritizes the SLAs of each policy, indicating which metrics are most prioritized when selecting resources. For example, “Cost” can be the highest priority, followed by “RTO,” “RPO,” and “CO2 emission.”

Consumer Customizable Parameters (201-b-9) indicates which parameters are allowed to be adjusted by the consumer, such as RTO, RPO, storage cost, and other metrics. The consumer can customize these parameters within a predefined range to meet their specific requirements.

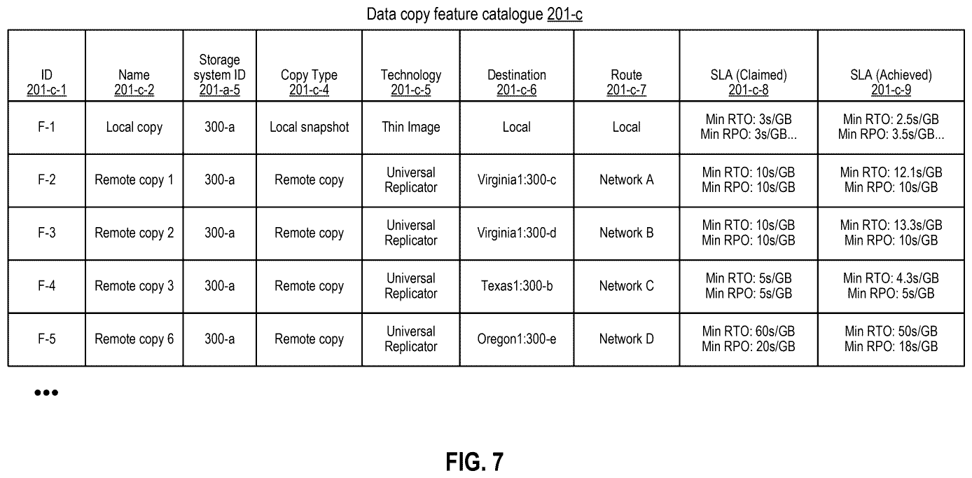

FIG. 7 illustrates the data copy feature catalogue, in accordance with an example implementation. This figure shows the data copy feature catalogue that contains information about the available data copy features that can be used for data protection. The table, labeled as “Data copy feature catalogue 201-c,” lists data replication technologies available in a storage management system, along with their attributes and service level agreements (SLAs).

ID (201-c-1) provides a unique identifier for each data copy feature.

Name (201-c-2) names each data copy feature or process, such as “Local copy,” “Remote copy 1,” “Remote copy 2,” and “Remote copy 3,” to identify the type of data copy operation.

Storage System ID (201-a-5) is the identifier for each storage system.

Copy Type (201-c-4) specifies the type of data copy operation type, such as “Local snapshot” for local copies and “Remote replication” for remote copies. The method of the data copy operations corresponds to the data copy technologies that are provided by the storage system and defined in Technology (201-c-4).

Technology (201-c-5) specifies the technology used for each data copy feature. For example, “Thin Image” could be used for local snapshots, while “Universal Replicator” could be used for remote replication.

Destination (201-c-6) identifies the target location and storage system for the data copy. For the local copy, the destination is marked as “local,” and for remote copies, it specifies other site locations, such as “Texas1: 300-c”, “Texas1: 300-d”, “Virginia1: 300-b” and “Oregon1: 300-e” which is the cloud storage system and so on.

Route (201-c-7) details the network route through which the data is copied. “Local” is used for local copies, while remote copies are done through different network routes labeled as “Network A,” “Network B,” and “Network C.”

SLA (Claimed) (201-c-8) provides the claimed or targeted service level objectives for each data copy operation, such as minimum Recovery Time Objective (RTO) and Recovery Point Objective (RPO) metrics.

SLA (Achieved) (201-c-9) presents historical data on the actual achieved SLAs for each data copy operation, offering a record of past performance against the claimed objectives. The achieved SLAs could be based on real-time monitoring, historical data, or other performance metrics that track the effectiveness of the data copy operations by the storage monitoring system 206. The information in this column can be included the date information when the SLAs were achieved.

Every row in the table represents available data copy features between the source (201-c-2) and destination (201-c-4) storage systems. For example, the second row indicates a possible data copy operation from “Texas1: 300-a” to “Virginia1: 300-c” using the “Universal Replicator” technology.

The “Route” column specifies the network path used for the data transfer, such as “Network A.” The claimed SLAs are the service level agreements that the data copy feature aims to meet, such as the Recovery Time Objective (RTO) and Recovery Point Objective (RPO). By contrast, the achieved SLAs represent the actual (realized) performance of the data copy feature.

The achieved SLA values can be based on historical data, real-time monitoring, or other performance metrics that track the effectiveness of the data copy operations.

Table 202-a, 202-b and 202-c are the databases that are used in the resource management module.

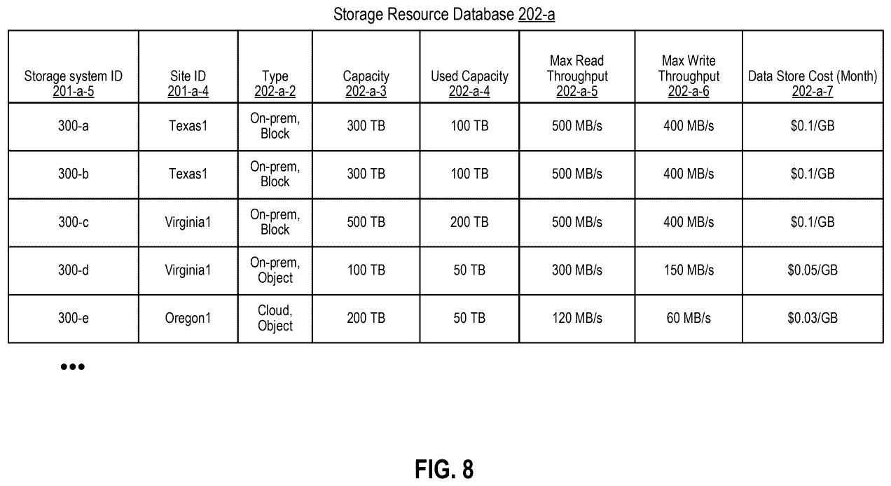

FIG. 8 illustrates an example of the storage resource database, in accordance with an example implementation. The table labeled as “Storage Resource Database 202-a” contains information about the storage systems available for use within the storage management system. The table includes columns such as Storage System ID, Site ID, Type, Capacity, Max Read Throughput, Max Write Throughput, and Data Store Cost (Month).

Storage System ID (201-a-1) is a unique identifier for each storage system.

Site ID (201-a-4) is the identifier for each site where the storage system is located, such as “Texas 1,” “Oregon 1,” “Virginia 1,” and so on.

Type (201-a-2) provides information on the type of storage each system provides, detailing whether it's an on-premises block storage, on-premises object storage, or cloud-based object storage.

Capacity (201-a-3) indicates the total storage capacity available in each system, listed in terabytes (TB).

Used Capacity (202-a-4) of each storage system is provided, which shows the amount of storage that is currently in use.

Max Read Throughput (201-a-5) for each storage system is provided, which is the rate at which data can be read from the storage, expressed in megabytes per second (MB/s).

Max Write Throughput (201-a-6) shows the maximum write throughput, which is the rate at which data can be written to the storage, also expressed in MB/s.

Data Store Cost (Month) (201-a-7) lists the cost of storing data on each system, expressed as a price per gigabyte per month.

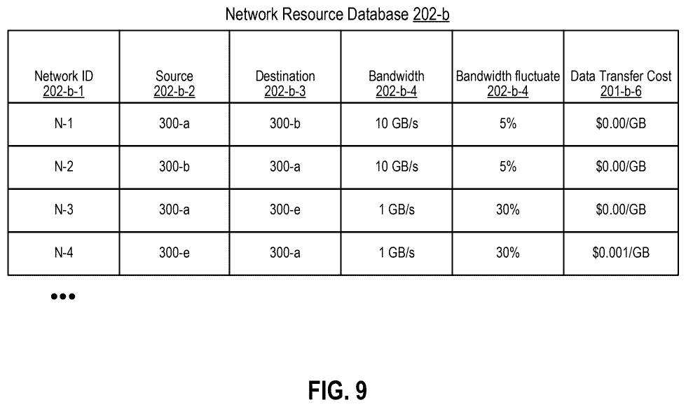

FIG. 9 illustrates a network resource database, in accordance with an example implementation. The table labeled as “Network Resource Database 202-b” contains information about the network resources available for use within the storage management system. The table includes columns such as Source, Destination, Bandwidth, Bandwidth Fluctuate, and Data Transfer Cost.

Network ID (202-b-1) provides a unique identifier for each network resource, which distinguishes each network path within the management infrastructure.

Source (202-b-2) lists the identifier of the source storage system or location from which data is being transmitted.

Destination (202-b-3) lists the identifier of the destination storage system or location to which data is being sent.

Bandwidth (202-b-4) indicates the network bandwidth available for data transfer between the source and destination. It is expressed in gigabits per second (Gb/s), denoting the capacity of the network link.

Bandwidth Fluctuate (202-b-5) indicates the percentage of bandwidth fluctuation, which represents the variability or stability of the network bandwidth.

Data Transfer Cost (202-b-6) provides the cost associated with transferring data across the network, expressed as a price per gigabyte of data transferred.

Each row in the table represents the network path between the source and destination storage systems, detailing the bandwidth, fluctuation, and cost associated with data transfer over that path. For example, the first row shows the network path between “Site 1-a: 300-a” and “Site 1-b: 300-c,” with a bandwidth of 10 Gb/s, a fluctuation rate of 5%, and a data transfer cost of $0.01 per gigabyte.

The fluctuation rate indicates the variability in bandwidth, which could impact the speed and reliability of data transfer between the systems. For example, a higher fluctuation rate means the network is less stable, leading to potential delays or interruptions in data transfer. The value of fluctuation can be calculated based on historical data or real-time monitoring of network performance.

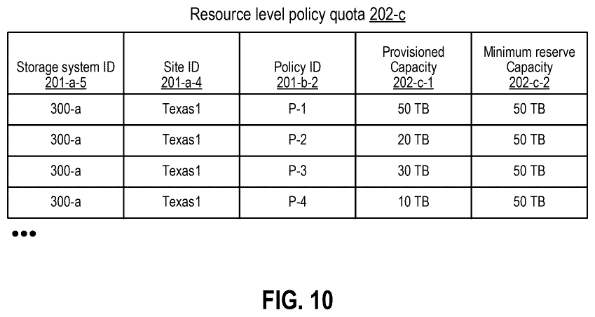

FIG. 10 illustrates an example of the resource level policy quota, in accordance with an example implementation. The table labeled as “Resource level policy quota 202-c” contains information about the resource level policy quota for each policy. The Minimum Reserve 202-c-1 column indicates the minimum reserved storage capacity for each policy in the storage system. This ensures that the policy can be allocated the required resources to meet the SLAs and avoid resource contention with other policies. The table may be configured for each site and each policy.

Storage System ID (201-a-5) identifies the storage system associated with each policy.

Site ID (201-a-4) specifies the site where the storage policies are applied.

Policy ID (201-b-2) provides a unique identifier for each policy.

Provisioned Capacity (202-c-1) indicates the currently provisioned storage capacity for each policy. For example, the storage system 300-a in Texas1 has provisioned 50 TB for policy P-1, and 20 TB for policy P-2 and so on.

Minimum Reserve Capacity (202-c-2) indicates the minimum reserved storage capacity for each policy. For example, the storage system 300-a in Texas1 reserved 50 TB for policy P-1. When the other policy requests the storage capacity in the storage system 300-a, the resource management module 204 checks the Minimum Reserve capacity for each storage system and each policy. If the requested capacity consumes the Minimum Reserve capacity, the resource management module 204 declines the request.

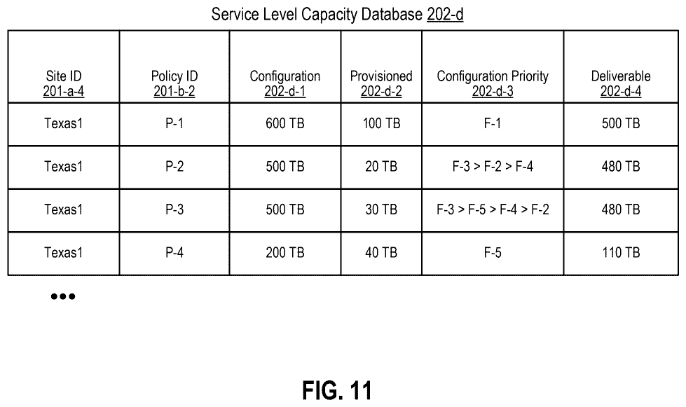

FIG. 11 illustrates an example of the service level capacity database, in accordance with an example implementation. The table labeled as “Service Level Capacity Database 202-d” contains information about the remaining resource capacity of the infrastructure for each policy. The table includes columns such as Site ID, Policy ID, Configurable, Provisioned, Configuration Priority, and Deliverable. The table may be configured for each site and each policy.

Site ID (201-a-4) identifies the site for which the policy provided, such as “Texas 1,” “Oregon 1,” “Virginia 1,” and so on.

Policy ID (202-b-2) specifies a unique identifier for each policy.

Configurable (202-d-1) indicates the maximum configurable capacity for each policy.

Provisioned (202-d-2) shows the currently provisioned storage capacity for each policy.

Configuration Priority (202-d-3) lists the configurable resource which are meet the SLAs of the policy. The priority of the configuration order for each policy is indicated in this column. Resources in this list preselected to meet the SLAs of the policy when the define the policy. The priority values include single options like “F-1” and “F-5” or ordered sequences like “F-3>F-2>F-4” and “F-3>F-5>F-4>F-2.” The priority values could be defined by the service provider based on resource availability, cost, performance, and other factors.

Deliverable (202-d-4) specifies the remaining resource capacity of the infrastructure for each policy regarding resource contention between policies.

The configurable column indicates the maximum capacity that can be allocatable for each policy with specified resources in Configuration Priority.

For example, the policy P-1 is local snapshot in Texas1 which is the policy does not have relationship with another storage sources, therefore the Configurable value is total capacity of storage systems in Texas1. On the other hand, the policy P-2 is multi region remote copy policy from Texas1 to other regions, therefore the Configurable for P-2 is the total capacity of storage systems in other regions unless not exceed the total capacity of storage systems in Texas1. The Configurable value for P-2 could be calculated by the following formula:

$${C}_{p 2} = min ( {C}_{texas 1} , {\sum }_{i = 1}^{n} {C}_{i} )$$

where Cₚ₂ is the configurable capacity for P-2, C_{Texas1} is the total capacity of storage systems in Texas1, Cᵢ is the total capacity of storage systems in other regions, and n is the number of storage systems in other regions which are indicated in configuration priority 202-d-3.

The deliverable column indicates the remaining resource capacity of the infrastructure for each policy which is regarding the resource contention between policies. The deliverable value could be calculated by resource management module 204 based on the information from the Storage Resource Database 202-a, Network Resource Database 202-b and provisioned capacity by the policy. For example, the Deliverable value for P-2 could be calculated by the following formula:

Dₚ₂=Cₚ₂−Pₚ₂−Sₚ₂

Where Dₚ₂ is the deliverable capacity for P-2, Cₚ₂ is the configurable capacity for P-2, and Pₚ₂ is the provisioned capacity for P-2, and Sₚ₂ is the provisioned capacity for the other policies that are sharing the resources with P-2 which is sum of Provisioned Capacity 202-c-1 for the other policies that are sharing the resources with P-2.

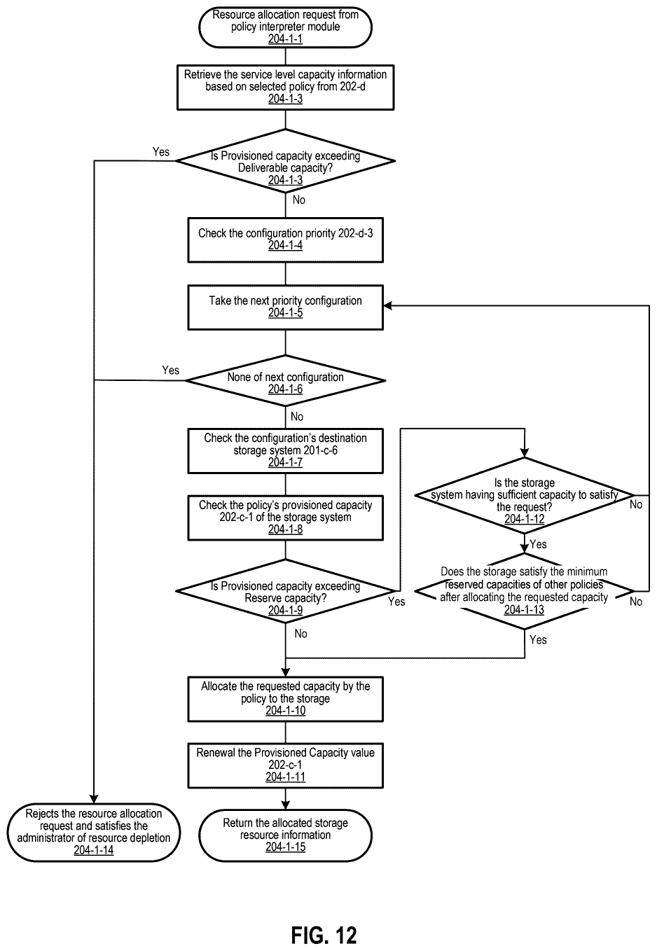

FIG. 12 illustrates the resource allocation process in the resource management module, in accordance with an example implementation. This figure shows the resource allocation process in the resource management module when a resource allocation request is received from the policy interpreter module 203.

At 204-1-1, a resource allocation request is received from the policy interpreter module. This request initiates the resource allocation process in the resource management module 204. At 204-1-2, the system retrieves service level capacity information for the policy from the database identified as “202-d.” At 204-1-3 the system checks if the provisioned capacity exceeds the deliverable capacity for the selected policy. If Yes, the process skips to step 204-1-14, where the request is rejected because the provisioned capacity exceeds the deliverable capacity. Otherwise (No) the process moves to the next step, 204-1-4.

At 204-1-4 the system checks the configuration priority for the selected policy, based on “202-d-3,” to determine which configurations are preferred for resource allocation. At 204-1-5, the system takes the next configuration based on the priority order in the previous step. This allows the system to allocate resources according to predefined priorities by the service provider. At 204-1-6 the system checks if there are any additional configurations left in the priority sequence. If Yes, then the available configurations are depleted, and the process moves to step 204-1-14 to reject the allocation request. Otherwise (No) the process continues to the next check in step 204-1-7.

At 204-1-7, the system identifies the destination storage system for the configuration, based on data from “201-c-6,” ensuring that the resource allocation aligns with the appropriate storage system. At 204-1-8, the system obtains provisioned capacity information for the selected policy from “202-c-1,” which indicates the current capacity allocated to the policy. At 204-1-9, the system checks if the provisioned capacity exceeds the reserved capacity for the selected policy. If Yes, then the system proceeds to step 204-1-12 to verify the available storage system capacity. Otherwise (No), the process moves forward to step 204-1-10.

At 204-1-12, the system checks if the storage system has sufficient capacity to satisfy the requested allocation. If No, then the system checks the next candidate configuration in step 204-1-5. Otherwise (Yes) the process moves to step 204-1-13.

At 204-1-13, the system checks if the storage meets the minimum reserved capacities of other policies after accepting the requested capacity. If No, this means that the selected storage system does not have enough capacity to meet the minimum reserved capacities of other policies. Therefore, the system moves to step 204-1-5 to check the next candidate configuration. Otherwise (Yes) the process moves to step 204-1-10.

At 204-1-10, the system allocates the requested capacity to the storage for the selected policy. This step confirms that the requested resources are allocated successfully. At 204-1-11, the system updates the provisioned capacity value in “202-c-1” to reflect the newly allocated capacity.

At 204-1-15, the system returns the allocated storage resource information to confirm the successful allocation and provide details of the allocated resources to the policy interpreter module 203.

At 204-1-14 (the alternative path), if any of the conditions throughout the process are not met (as indicated in the decision points), the system rejects the resource allocation request and notifies the administrator of resource depletion. This step ensures that administrators are informed of capacity issues that prevent resource allocation.

Through the example implementations described herein, concise and accurate resource capacity management for each policy regarding the shared resources between policies can be provided. Example implementations can avoid resource contention between policies and it can guarantee policy has strict requirements can be deployed without resource contention with other less strict requirements policies. With accurate resource capacity management, the storage provider can optimize the system resources to meet the end-users' demands and to reduce the cost of the infrastructure. The storage provider can maximize the utilization of the infrastructure resources.

Example implementations described herein can reduce the risk of human error for backup operations because the copy data management system uses the pre-defined policies to automate the backup process meeting the SLAs such as RTO, RPO, storage cost, emission of CO2, data restriction on the geographical location, and so on.

Example implementations can detect the risk of the SLAs violation that is caused by the change of the real workload on the IT systems. The copy data management system can automatically adjust the selected system resources to meet the SLAs.

Example implementations can help the system provider to optimize the system resources because the copy data management system can detect the system resources that are not meeting the SLAs which are requested by the consumer. The system provider can optimize the system resources based on the detected information.

In the quality evaluation of the copy feature, sensitivity of divergence between the achieved SLAs and the claimed SLAs could be adjusted by the service level agreement between the service provider and the consumer. For example, the system could be set the tight sensitivity when the consumer pays the high cost for the service, and the system could be set the loose sensitivity when the consumer pays the low cost for the service.

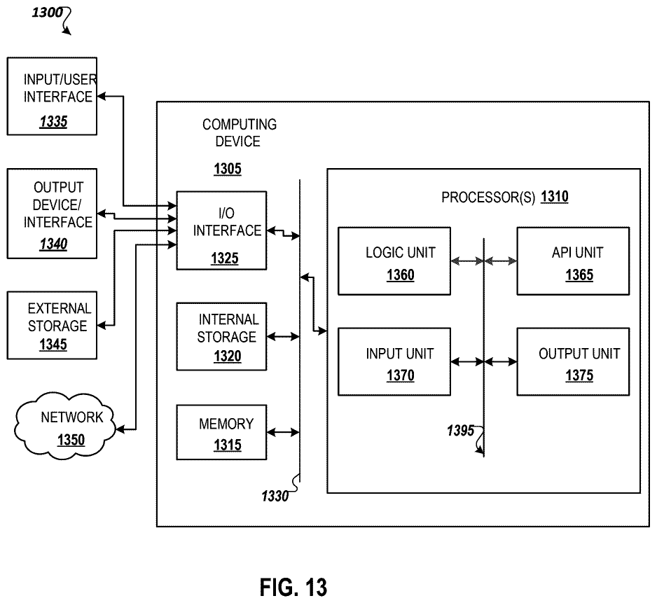

FIG. 13 illustrates an example computing environment with an example computer device suitable for use in some example implementations, such as a storage management system 200 as illustrated in FIG. 2, or the storage systems described herein. Computer device 1305 in computing environment 1300 can include one or more processing units, cores, or processors 1310, memory 1315 (e.g., RAM, ROM, and/or the like), internal storage 1320 (e.g., magnetic, optical, solid state storage, and/or organic), and/or I/O interface 1325, any of which can be coupled on a communication mechanism or bus 1330 for communicating information or embedded in the computer device 1305. I/O interface 1325 is also configured to receive images from cameras or provide images to projectors or displays, depending on the desired implementation.

Computer device 1305 can be communicatively coupled to input/user interface 1335 and output device/interface 1340. Either one or both of input/user interface 1335 and output device/interface 1340 can be a wired or wireless interface and can be detachable. Input/user interface 1335 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1340 may include a display, television, monitor, printer, speaker, braille, or the like. In some example implementations, input/user interface 1335 and output device/interface 1340 can be embedded with or physically coupled to the computer device 1305. In other example implementations, other computer devices may function as or provide the functions of input/user interface 1335 and output device/interface 1340 for a computer device 1305.

Examples of computer device 1305 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1305 can be communicatively coupled (e.g., via I/O interface 1325) to external storage 1345 and network 1350 for communicating with any number of networked components, devices, and systems, including one or more computer devices of the same or different configuration. Computer device 1305 or any connected computer device can be functioning as, providing services of, or referred to as a server, client, thin server, general machine, special-purpose machine, or another label.

I/O interface 1325 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1300. Network 1350 can be any network or combination of networks (e.g., the Internet, local area network, wide area network, a telephonic network, a cellular network, satellite network, and the like).

Computer device 1305 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1305 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 1310 can execute under any operating system (OS) (not shown), in a native or virtual environment. One or more applications can be deployed that include logic unit 1360, application programming interface (API) unit 1365, input unit 1370, output unit 1375, and inter-unit communication mechanism 1395 for the different units to communicate with each other, with the OS, and with other applications (not shown). The described units and elements can be varied in design, function, configuration, or implementation and are not limited to the descriptions provided. Processor(s) 1310 can be in the form of hardware processors such as central processing units (CPUs) or in a combination of hardware and software units.

In some example implementations, when information or an execution instruction is received by API unit 1365, it may be communicated to one or more other units (e.g., logic unit 1360, input unit 1370, output unit 1375). In some instances, logic unit 1360 may be configured to control the information flow among the units and direct the services provided by API unit 1365, input unit 1370, output unit 1375, in some example implementations described above. For example, the flow of one or more processes or implementations may be controlled by logic unit 1360 alone or in conjunction with API unit 1365. The input unit 1370 may be configured to obtain input for the calculations described in the example implementations, and the output unit 1375 may be configured to provide output based on the calculations described in example implementations.

Processor(s) 1310 can be configured to execute a method or instructions involving, for a selection of a policy for resource allocation (204-1-1), retrieving a configuration priority for the selected policy (204-1-4); determining a destination storage system for the retrieved configuration priority (204-1-7); and determining provisioned capacity of the destination storage system; for the provisioned capacity exceeding a reserve capacity of the destination storage system (204-1-9): retrieving a next configuration priority for the selected policy for when the destination storage system has insufficient capacity for the configuration priority, or for when the destination storage system cannot satisfy minimum reserve capacities of other policies should requested capacity be allocated for the configuration priority (204-1-5, 204-1-12, 204-1-13); and allocating the requested capacity for the selected policy for when the destination storage system has sufficient capacity for the configuration priority and for when the destination storage system can satisfy minimum reserve capacities of the other policies should the requested capacity be allocated for the configuration priority (204-1-5, 204-1-12, 204-1-13, 204-1-10) as illustrated in FIG. 12.

Processor(s) 1310 can be configured to execute the method or instructions above, and further include, for the provisioned capacity exceeding a deliverable capacity of the destination storage system, rejecting the selection and providing a message indicative of resource depletion (204-1-14) as illustrated in FIG. 12.

Processor(s) 1310 can be configured to execute the method or instructions above, wherein the deliverable capacity is determined from a difference between a configurable capacity of the destination storage system and a total of the provisioned capacity of the destination storage system and provisioned capacity of other configuration policies of the destination storage system as described with respect to 204-1-7, 204-1-8, 204-1-9 in FIG. 12.

Processor(s) 1310 can be configured to execute the method or instructions as described above, and further involve, for the provisioned capacity not exceeding the reserve capacity of the destination storage system, allocating the requested capacity according to the selected policy to the destination storage system; and updating the provisioned capacity of the destination storage system (204-1-9, 204-1-10) as illustrated in FIG. 12.

Processor(s) 1310 can be configured to execute the method or instructions as described above, wherein the minimum reserve capacities are adjusted for the destination storage system based on a level of demand of policies managed by the destination storage system as described with respect to FIG. 11.

Processor(s) 1310 can be configured to execute the method or instructions as described above, and further include providing a management interface configured to set the configuration priority for each policy managed for the destination storage system as described with respect to FIGS. 3, 4, and the policy interpreter module 203.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
for a selection of a policy for resource allocation:
retrieving a configuration priority for the selected policy;
determining a destination storage system for the retrieved configuration priority; and
determining provisioned capacity of the destination storage system;
for the provisioned capacity exceeding a reserve capacity of the destination storage system:
retrieving a next configuration priority for the selected policy for when the destination storage system has insufficient capacity for the configuration priority, or for when the destination storage system cannot satisfy minimum reserve capacities of other policies should requested capacity be allocated for the configuration priority; and
allocating the requested capacity for the selected policy for when the destination storage system has sufficient capacity for the configuration priority and for when the destination storage system can satisfy minimum reserve capacities of the other policies should the requested capacity be allocated for the configuration priority.

2. The method of claim 1, further comprising, for the provisioned capacity exceeding a deliverable capacity of the destination storage system, rejecting the selection and providing a message indicative of resource depletion.

3. The method of claim 2, wherein the deliverable capacity is determined from a difference between a configurable capacity of the destination storage system and a total of the provisioned capacity of the destination storage system and provisioned capacity of other configuration policies of the destination storage system.

4. The method of claim 1, further comprising, for the provisioned capacity not exceeding the reserve capacity of the destination storage system, allocating the requested capacity according to the selected policy to the destination storage system; and updating the provisioned capacity of the destination storage system.

5. The method of claim 1, wherein the minimum reserve capacities are adjusted for the destination storage system based on a level of demand of policies managed by the destination storage system.

6. The method of claim 1, further comprising providing a management interface configured to set the configuration priority for each policy managed for the destination storage system.

7. A non-transitory computer readable medium, storing instructions for executing a process, comprising:
for a selection of a policy for resource allocation:
retrieving a configuration priority for the selected policy;
determining a destination storage system for the retrieved configuration priority; and
determining provisioned capacity of the destination storage system;
for the provisioned capacity exceeding a reserve capacity of the destination storage system:
retrieving a next configuration priority for the selected policy for when the destination storage system has insufficient capacity for the configuration priority, or for when the destination storage system cannot satisfy minimum reserve capacities of other policies should requested capacity be allocated for the configuration priority; and
allocating the requested capacity for the selected policy for when the destination storage system has sufficient capacity for the configuration priority and for when the destination storage system can satisfy minimum reserve capacities of the other policies should the requested capacity be allocated for the configuration priority.

8. The non-transitory computer readable medium of claim 7, the instructions further comprising, for the provisioned capacity exceeding a deliverable capacity of the destination storage system, rejecting the selection and providing a message indicative of resource depletion.

9. The non-transitory computer readable medium of claim 8, wherein the deliverable capacity is determined from a difference between a configurable capacity of the destination storage system and a total of the provisioned capacity of the destination storage system and provisioned capacity of other configuration policies of the destination storage system.

10. The non-transitory computer readable medium of claim 7, the instructions further comprising, for the provisioned capacity not exceeding the reserve capacity of the destination storage system, allocating the requested capacity according to the selected policy to the destination storage system; and updating the provisioned capacity of the destination storage system.

11. The non-transitory computer readable medium of claim 7, wherein the minimum reserve capacities are adjusted for the destination storage system based on a level of demand of policies managed by the destination storage system.

12. The non-transitory computer readable medium of claim 7, the instructions further comprising providing a management interface configured to set the configuration priority for each policy managed for the destination storage system.

13. A storage management system, configured to manage one or more storage systems, comprising:
a processor, configured to:
for a selection of a policy for resource allocation:
retrieve a configuration priority for the selected policy;
determine a destination storage system from the one or more storage systems for the retrieved configuration priority; and
determine provisioned capacity of the destination storage system;
for the provisioned capacity exceeding a reserve capacity of the destination storage system:
retrieve a next configuration priority for the selected policy for when the destination storage system has insufficient capacity for the configuration priority, or for when the destination storage system cannot satisfy minimum reserve capacities of other policies should requested capacity be allocated for the configuration priority; and
allocate the requested capacity for the selected policy for when the destination storage system has sufficient capacity for the configuration priority and for when the destination storage system can satisfy minimum reserve capacities of the other policies should the requested capacity be allocated for the configuration priority.

14. The storage management system of claim 13, wherein the processor is configured to, for the provisioned capacity exceeding a deliverable capacity of the destination storage system, reject the selection and providing a message indicative of resource depletion.

15. The storage management system of claim 14, wherein the deliverable capacity is determined from a difference between a configurable capacity of the destination storage system and a total of the provisioned capacity of the destination storage system and provisioned capacity of other configuration policies of the destination storage system.

16. The storage management system of claim 13, wherein the processor is configured to, for the provisioned capacity not exceeding the reserve capacity of the destination storage system, allocate the requested capacity according to the selected policy to the destination storage system; and updating the provisioned capacity of the destination storage system.

17. The storage management system of claim 13, wherein the minimum reserve capacities are adjusted for the destination storage system based on a level of demand of policies managed by the destination storage system.

18. The storage management system of claim 13, wherein the processor is configured to provide a management interface configured to set the configuration priority for each policy managed for the destination storage system.
